(19) United States
(12) Patent Application Publication
(10) Pub. No.: US 2009/0214830 A1
(43) Pub. Date: Aug. 27, 2009

(54) Sheet for waterproofing and waterproofing method

(75) Inventors: Noriyuki Ito, Hyogo (JP); Yoshinori Mitsui, Hiratsuka (JP)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 11/918,724

(22) PCT Filed: Apr. 21, 2006
(86) PCT No.: PCT/EP2006/061759

§ 371 Date: Jan. 26, 2009

(30) Foreign Application Priority Data
Apr. 22, 2005 (JP) 2005-125734

(51) Int. Cl. B32B 3/26; B32B 37/00

(52) U.S. Cl. 428/172; 156/60

(57) ABSTRACT

To provide a waterproofing method for architectures in which while ensuring there is no peeling of the waterproof coating from the substrate and no cracking of the coating, there is also superior workability and no application of an adhesive to the substrate.

To carry out waterproofing with a sheet for waterproofing comprising a layered structure of an air-releasing layer comprising a non-adhesive film or sheet having pores and an adhesive layer, wherein at least a part of the air-releasing layer and/or the adhesive layer protrudes from the layered structure.

### TECHNICAL FIELD

The present invention relates to a waterproofing method for architectures or constructions and a sheet for waterproofing used in such method.

### BACKGROUND OF THE INVENTION

Conventionally, as a waterproofing method for a roof of an architecture or a construction made of concrete or the like, a coating waterproofing method wherein a waterproof coating is formed by applying a waterproofing material such as a polyurethane-based waterproofing material to the surface of a roof substrate is known.

However, in coating waterproofing methods, water and the like retained on the substrate are vaporized and expanded by heat from the sun. The result being, there is the problem that the coating peels from the substrate and cracks appear in the coating, causing the waterproofing function to be lost. Also, when surface irregularities are large, irregularities also appear in the surface of the coating, resulting in a loss of aesthetic appearance.

As disclosed in Japanese Unexamined Patent Application, First Publication No. H07-144393 and Japanese Unexamined Patent Application, First Publication No. 2004-131955, it is suggested that a nonwoven fabric sheet layered with a polyurethane film is stuck onto the substrate using an adhesive. In this situation, moisture and the like from the substrate passes through air spaces in the nonwoven fabric sheet, used as an air-releasing layer, and is released to the outside air from an air-releasing device such as an air-releasing tube. Therefore, peeling and cracking can be avoided. Also, irregularities in the surface of the substrate can be absorbed by the nonwoven fabric sheet. Therefore, the formation of irregularities in the surface of the coating can be prevented.

However, when a nonwoven fabric sheet is used as an air-releasing layer in this way, a nonwoven fabric sheet having a small degree of density and a large mass per unit area must be used in order to ensure sufficient air-releasing properties. Therefore, the waterproofing layer, as a whole, becomes thick and there is deterioration in workability. Also, a step of applying an adhesive to the surface of the substrate is necessary. Furthermore, there is the possibility that the adhesive will deteriorate by being affected by water and the like from the substrate.

Also, in Japanese Unexamined Patent Application, First Publication No. 2001-303723, it is suggested that a sheet having grooves in the rear surface as a means for releasing air is stuck onto the surface of a substrate by an adhesive. In this situation, moisture and the like from the substrate is released to the outside air along the grooves.

However, when a sheet having grooves is used as an air-releasing layer in this way, a comparatively thick sheet is needed to be used in order to form grooves of the desired depth and there is also deterioration in workability. Also, in cold conditions such as winter, it is easy for cracking to occur in the grooved parts and in hot conditions such as summer, the grooves gradually deform and shrink or disappear. Therefore, as well as the air-releasing properties not being able to be maintained for the long-term, there is also the problem that the surface of the coating is deformed. Also, a step of applying an adhesive to the surface of substrate is necessary. Furthermore, there is the possibility that the adhesive will deteriorate by being affected by water and the like from the substrate.

### SUMMARY OF THE INVENTION

In consideration of the situation of the above-mentioned background art the object of the present invention is to provide a waterproofing method for architectures or constructions in which there is superior workability and no application of an adhesive to the substrate, while ensuring there is no peeling of the waterproof coating from the substrate and no cracking of the coating.

The object of the present invention is accomplished by a sheet for waterproofing comprising a layered structure of an air-releasing layer comprising a non-adhesive film or sheet having pores and an adhesive layer, wherein at least a part of the air-releasing layer and/or the adhesive layer protrudes from the layered structure.

It is preferable that the air-releasing layer has air-releasing passages with a maximum width of 3 mm to 20 mm. Also, it is preferable that a waterproof layer is formed on top of the adhesive layer.

Furthermore, it is preferable that the sheet for waterproofing of the present invention is provided with an intermediate layer between the adhesive layer and the waterproof layer. Also, in particular, a nonwoven fabric with an interlamellar strength of 100 g/cm or more is preferable as the intermediate layer.

The above-mentioned sheet for waterproofing can be constructed by sticking the air-releasing layer onto the substrate surface of an architecture or a construction.

The air-releasing layer of the sheet for waterproofing of the present invention is comprised of a thin film or sheet. Therefore, the thickness of the entire sheet for waterproofing of the present invention can be suppressed. Accordingly, while ensuring that peeling of the sheet for waterproofing from the substrate surface of architectures or constructions and cracking of the sheet for waterproofing can be avoided, waterproofing can be carried out with superior workability. Also, application of an adhesive to the substrate is unnecessary. Therefore, the waterproofing period can be shortened. Furthermore, there is no possibility that the adhesive will be deformed by water and the like from the substrate.

Furthermore, in the sheet for waterproofing of the present invention, at least a part of the air-releasing layer and/or adhesive layer protrudes from the layered structure. Therefore, it is easy to join sheets together. Also, the air-releasing layer is not present in the position where sheets join. Therefore, entry of water from the outside can be prevented. Furthermore, even if pressure is applied to the above-mentioned position where sheets join, air-releasing performance is not affected. In particular, when the air-releasing passages of the air-releasing layer have a maximum width of 3 mm to 20 mm, there is no affect to the shape of the surface of the coating and furthermore, air-releasing performance is increased.

Also, when the waterproof layer is formed in advance on the surface of the adhesive layer of the sheet for waterproofing of the present invention, application of the waterproofing material at the construction site is unnecessary and furthermore, waterproofing is easy. Also, when an intermediate layer is present between the waterproof layer and the adhesive layer, the intermediate layer absorbs the irregularities of the substrate. Therefore, the smoothness of the surface of the waterproof layer can be well maintained. Furthermore, adhesiveness between the waterproof layer and the adhesive layer can be further improved by arbitrarily selecting the material of the intermediate layer. In particular, when the intermediate layer is a nonwoven fabric, fluffing over time can be decreased and also, wear resistance of the entire sheet for waterproofing can be increased by using a nonwoven fabric with an interlamellar strength of 100 g/cm or more.

Below, the present invention will be explained in detail using the drawings.

FIG. 1 is a cross-sectional view showing an example of an embodiment of the sheet for waterproofing of the present invention and FIG. 2 is a plan view from the side of the air-releasing layer 1 in FIG. 1.

In the examples shown in FIGS. 1 and 2, the sheet for waterproofing is constituted of an adhesive layer 2 being layered on one surface of the air-releasing layer 1. As is clear from FIG. 2, the air-releasing layer 1 is comprised of a non-adhesive film or sheet having pores 1b and the pores form the positions of adhesion between the adhesive layer 2 and the substrate. On the other hand, nonporous positions of the air-releasing layer (positions of non-adhesion) function as air-releasing passages 1a. In other words, when air and water included in the substrate as well as air retained in the adhesive surface between the substrate and the sheet for waterproofing is vaporized and expanded by being warmed with heat from the sun and the like, this air or vapor is released to the outside by being led along the air-releasing passages 1a to an air-releasing tube (not shown) or the like. Accordingly, in the present invention, swelling of the sheet for waterproofing by the above-mentioned water or vapor can be avoided as well as peeling of the sheet for waterproofing from the substrate and cracking of the sheet for waterproofing can be prevented.

The rate of porosity of the air-releasing layer 1 is preferably 25 to 90% and more preferably 30 to 65%. If the rate of porosity is less than 25%, there is the possibility that adhesiveness of the air-releasing layer 1 to the substrate will be insufficient and if the rate of porosity exceeds 90% there is the possibility that it is difficult to ensure sufficient air-releasing performance.

As long as a film or sheet having pores is used for the air-releasing layer 1, there are no particular limitations on the materials that can be used for the film or sheet. However, a plastic sheet or film consisting of the thermoplastic resin such as polyethylene, polypropylene, or polyester is preferable. Also, instead of a plastic film or sheet, for example, a net formed by laying plastic strips with a width of 1 to 20 mm, preferably 2 to 10 mm, crisscross or diagonally can be used. Examples of nets include “SOF” (trade name) by Sekisui Film Co. Ltd., and “CLAF” (trade name) by Nisseki Plasto Co., Ltd. The air-releasing layer 1 may be constituted from one film, sheet, or net or may be a layered body of a plurality of films, sheets, or nets.

When an embossed film or sheet is used as the air-releasing layer 1, the surface is irregular. Therefore, air-releasing properties can be further ensured and is further preferable as the air-releasing layer 1. From the point of further ensuring air-releasing properties, use of a layered body formed by arbitrarily selecting and joining embossed plastics films or sheets is even more preferable.

There are no particular limitations to the shape of the pores 1b and they can be arbitrary shapes such as ceratoids, such as triangles, tetragons (includes squares and rectangles), and pentagons, circles and ovals. Also, the spacing of the pores is arbitrary. For example, when the pores are circular, as required, pores with a diameter 5 to 100 mm, preferably 10 to 80 mm, and a spacing of 5 to 100 mm, preferably 10 to 80 mm, can be formed in the air-releasing layer 1. It is not necessary that the shape, size, and spacing of each of the pores 1b match. However, the air-releasing passage must be continuous in order for the air-releasing properties of the air-releasing layer 1 to be maintained. Therefore, when a plurality of pores 1b is formed, they must be arranged discontinuously.

It is possible to increase the amount of air flow by arbitrarily selecting the shape of the pores 1b without largely changing the rate of porosity of the air-releasing layer 1. For example, as the shape of the pores 1b, it is preferable to use a shape which can as much as possible maintain the linearity of the air-releasing passages 1a an order to minimize air resistance. As shown in FIG. 2, a plurality of rows of rectangular pores 1b is provided in the air-releasing layer 1 in order for the entirety of the air-releasing passages 1a to be linear. Therefore, this is particularly preferable. For the pattern of pores 1b shown in FIG. 2, when the air-releasing passages are at the maximum a width of 3 to 20 mm, preferably 6 to 20 mm, while maintaining the smoothness of the surface of the air-releasing sheet, the amount of air flow can be increased.

The thickness of the air-releasing layer 1 is typically 1 to 1000 μm, preferably 10 to 200 μm, and more preferably 15 to 100 μm. In the present invention, the air-releasing layer 1 is thin. Therefore, it is possible to suppress the entire thickness and workability can be increased by reducing the weight of the sheet for waterproofing. Also, there are no air-releasing grooves in the air-releasing layer 1. Therefore, cracks do not appear in the air-releasing layer 1 even in cold conditions such as winter and there is no gradual and deformation and shrinking or disappearance of the grooves even in hot conditions such as summer. Accordingly, there is no deformation in the surface of the sheet for waterproofing. Therefore, a long-term aesthetic appearance can be maintained.

The adhesive layer 2 has a function of sticking the air-releasing layer 1 to the substrate via the pores 1b of the air-releasing layer 1. Accordingly, when the sheet for waterproofing of the present invention is fixed to the substrate, there is no need to apply an adhesive to the substrate in advance. Therefore, there is no possibility that adhesive power is reduced through deformation of the adhesive by being affected by water from the substrate. Also, it is possible to reduce the steps in waterproofing by avoiding work requiring the skill of applying an adhesive uniformly to the substrate. Furthermore, when cracks appear in the substrate, the adhesive layer 2 absorbs this behaviour and exhibits the function of a secondary waterproofing of the coating.

It is preferable that the adhesive layer 2 is an adhesive non-vulcanized rubber sheet, the main component being natural rubber or synthetic rubber and as required, an adhesion-imparting resin, a softener, a filler, and an antioxidant can be added. A butyl rubber with superior durability is optimum as the rubber. The thickness of the sheet is preferably 0.2 to 3.0 mm and more preferably 0.5 to 2.0 mm.

The sheet for waterproofing is marketed after, for example, a release paper (not shown) is attached to the surface of the adhesive layer 2 to be stuck to the substrate. The sheet for waterproofing of the present invention can be easily constructed by, after removing the release paper (not shown), the air-releasing layer 1 is made to come into contact with the substrate and stuck by the adhesive layer 2.

It is possible to give the sheet for waterproofing of the present invention shown in FIG. 1 waterproof properties by forming a waterproof layer by applying and drying a waterproof material such as a polyurethane-based waterproof material to the surface of the sheet for waterproofing of the present invention shown in FIG. 1. However, as shown in FIG. 3, it is preferable to form an intermediate layer 3 on the surface of the adhesive layer 2 in order to improve adhesion between the waterproofing material and the adhesive layer 2. The intermediate layer 3 absorbs irregularities of the substrate. Therefore, there is also the effect that the smoothness of the surface of the waterproof layer is maintained.

As long as the adhesion between the adhesive layer 2 and the waterproof layer can be increased, there are no particular limitations on the materials that can be used as the intermediate layer 3. However, the intermediate layer 3 is typically a nonwoven fabric sheet, a plastic film, a plastic foam, or a layered body of these.

A polyester, polypropylene, rayon, vinylon, or polyurethane-base nonwoven fabric sheet can be used as the non-woven fabric sheet. However, use of a common polyester spunbonded nonwoven fabric is economical. As the mass per unit area of the nonwoven fabric, 10 to 200 g/m² is preferable and 35 to 100 g/m² is more preferable. Also, the interlamellar strength of the nonwoven fabric is preferably 100 g/cm and particularly preferably 300 g/cm. By using a nonwoven fabric with a high interlamellar strength, fluffing over time can be reduced and also, wear resistance of the entire sheet for waterproofing can be improved.

The above-mentioned interlamellar strength is measured according to the following method. Firstly, along with cutting out a sample of size 5 cm×10 cm from the nonwoven fabric, a dummy nonwoven fabric of the same size is prepared. Next, the dummy nonwoven fabric is folded in two. The above-mentioned sample and the dummy woven fabric are joined and strong craft tape is stuck to the entire front and rear surfaces so that the above-mentioned sample and the dummy nonwoven fabric become 5 cm×15 cm and the folded side of the dummy nonwoven fabric becomes one side of the 5 cm×15 cm rectangle. After cutting the folded side of the dummy nonwoven fabric into two with a knife or the like, a layer is peeled by hand about 3 cm from the left and right of one surface of the dummy nonwoven fabric. After this, both sides which have been peeled are set above and below a clamp of a tension tester. The tensile test is carried out with the distance between the clamp being 5 cm and the head speed being 200 cm/min. At the time of elongation, the three largest and the three smallest values of stress were read and the average of these 6 values was used to give one interlamellar strength. This test was carried out three times and the average of the three interlamellar strengths was used to give the interlamellar strength.

A polyethylene-based, polypropylene-based, polyester-based, polyvinyl chloride based, polyurethane-based film, or the like can be used as the plastic film. It is preferable that the thickness is 10 to 50 μm. Also, a polyethylene-based, polyvinyl chloride-based, polyurethane-based foam, or the like can be used as the plastic foam. It is preferable that the foaming ratio is 5 to 50 times and the thickness of the foam is 0.5 to 5 mm.

The sheet for waterproofing of the present invention shown in FIG. 1 to FIG. 3 is formed with a waterproof layer by applying and drying a waterproofing material on the surface of the adhesive layer 2 or the intermediate layer 3 after sticking the sheet for waterproofing of the present invention onto the substrate. However, other than this, a sheet for waterproofing which is formed in advance with a water-proof layer on the surface of the adhesive layer 2 or the intermediate layer 3 may be stuck onto the substrate in the present invention.

FIG. 4 shows an example of a sheet for waterproofing of the present invention with a waterproof layer 4 formed in advance on the surface of the intermediate layer 3. Any material can be used as the waterproof layer 4 as long the material has waterproofing properties. However, it is optimum to use a known waterproofing material such as urethanes, acrylics, polyesters, rubber asphalts, polymer cements, cements, asphalts, or vinyl chlorides.

As shown in FIG. 5, the sheet for waterproofing shown in FIG. 4 is constructed by sticking and fixing the sheet for waterproofing when the air-releasing layer 1 is made to contact a substrate 5. In this situation, it is unnecessary to form the waterproof layer 4 at the construction site. Therefore, the steps of waterproofing can be further reduced.

In the examples of the sheets for waterproofing of the present invention in FIGS. 1 to 5, the widths of the adhesive layer 2, the intermediate layer 3, and the waterproof layer 4 are greater than the width of the air-releasing layer 1. Also, an edge of the adhesive layer 2, the intermediate layer 3, and the waterproof layer 4 protrudes externally from the layered part with the air-releasing layer 1. Therefore, the entire surface of the adhesive layer 2 is not covered by the air-releasing layer 1 and a part of the edge is exposed. Accordingly, joining of sheets for waterproofing of the present invention can be carried out easily. Even in examples other than those shown in FIGS. 1 to 5, for the sheet for waterproofing of the present invention, a part of the air-releasing layer 1 may protrude from the layered region with the adhesive layer 2 by making the width of the air-releasing layer 1 larger than the width of the adhesive layer 2. In particular, it is preferable that the edges of the air-releasing layer 1 and the adhesive layer 2 protrude in different directions from the layered region of the air-releasing layer 1 and the adhesive layer 2. This point is explained below.

FIG. 6 is a cross-sectional view showing an example of the joining of a sheet for waterproofing in which the widths of the air-releasing layer 1, the adhesive layer 2, the intermediate layer 3, and the waterproof layer 4 are the same and formed by the entire surface of each layer being completely covered by the other layers and a sheet for waterproofing in which an air-releasing layer 1′, an adhesive layer 2′, an intermediate layer 3′, and a waterproof layer 4′ of equal widths are similarly layered and the edges are aligned vertically. In the example of FIG. 6, the edge of the air-releasing layer 1′ appears in the joining region and there is the possibility that water from the outside will enter from this part. Also, a space 6 will inevitably form. Therefore, if pressure is applied from above this part, the space 6 is easily flattened. Accordingly, there is the possibility that the air-releasing layer 1′ is greatly deformed and the air-releasing properties are lost.

On the other hand, FIG. 7 is a cross-sectional view showing an example of the joining of a sheet for waterproofing of the present invention in which a part of the air-releasing layer 1 protrudes to the left from the edge of the layered structure with the adhesive layer 2, the intermediate layer 3, and the waterproof layer 4 and a sheet for waterproofing of the present invention in which parts of the adhesive layer 2′, the intermediate layer 3′, and the waterproof layer 4′ protrude to the right from an edge of the layered structure with the air-releasing layer 1′. As is clear from the drawing, the air-releasing layer 1′ is not present in the joining region of sheets for waterproofing of the present invention. Accordingly, the entry of water from the joining region can be prevented. Furthermore, the space 6 like that shown in FIG. 6 does not form in the joining region. Therefore, even if pressure is applied from above, it is difficult for the air-releasing layers 1 and 1′ to be deformed. Accordingly, air-releasing properties can be well maintained.

The sheet for waterproofing of the present invention can be used in the waterproofing of architectures or constructions by being stuck onto the substrate surface of the architectures or the constructions.

As architectures, examples include houses and buildings. As constructions, examples include waterways, dams, tunnels, railway structures, and bridges.

### EXAMPLES

Examples based on the present invention will be explained below.

### Example 1

A polyester fiber spunbonded nonwoven fabric with a width of 1,000 mm and a mass per unit area of 30 g/m² was arranged as an intermediate layer on one surface of an adhesive non-vulcanized butyl rubber (components are shown in Table 1) of thickness 0.5 mm and width 1,000 mm as an adhesive layer formed using a calendar roll. After arranging as an air-releasing layer a polyethylene flat net with a width of 950 mm and air-releasing passages having a width of 3 mm arranged horizontally and vertically as a network on the other surface of the adhesive non-vulcanized butyl rubber, a release paper was applied to the surface of the net and a 20 m long sheet for waterproofing was obtained. The rate of porosity of the sheet for waterproofing was 50%.

TABLE 1

| Component | Parts by Weight |
|---|---|
| Butyl Rubber | 20.0 |
| Recycled Butyl Rubber | 10.0 |
| Adhesion-imparting Resin | 15.0 |
| Polybutune | 8.0 |
| Processed Oil | 4.0 |
| Calcium Oxide | 42.6 |
| Antioxidant | 0.4 |
| Total | 100.0 |

### Example 2

A polyester fiber spunbonded nonwoven fabric with a width of 1,000 mm and a mass per unit area of 30 g/m² was arranged as a intermediate layer on one surface of an adhesive non-vulcanized butyl rubber of thickness 0.5 mm and width 1,000 mm as an adhesive layer formed using a calendar roll. After arranging as an air-releasing layer a polyethylene with net with a width of 950 mm and horizontal air-releasing passages with a width of 3 mm and vertical air-releasing passages with a width of 6 mm in a network on the other surface of the adhesive non-vulcanized butyl rubber, a release paper was applied to the surface of the net and a 20 m long sheet for waterproofing was obtained. The rate of porosity of the sheet for waterproofing was 50%.

### Example 3

A polyester fiber spunbonded nonwoven fabric with a width of 1,000 mm and a mass per unit area of 30 g/m² was arranged as an intermediate layer on one surface of an adhesive non-vulcanized butyl rubber of thickness 0.5 mm and width 1,000 mm as an adhesive layer the same as Example 1. After arranging as an air-releasing layer a polyethylene flat net (manufactured by Sekisui Film Co. Ltd. trade name: Sekisui SOF GX-23) with a width of 950 mm on the other surface of the adhesive non-vulcanized butyl rubber, a release paper was applied to the surface of the net and a 20 m long sheet for waterproofing was obtained. The rate of porosity of the sheet for waterproofing was 42%.

### Example 4

The film side of a layered body formed by sticking together a polyester fiber spunbonded nonwoven fabric with a width of 1,000 mm and a mass per unit area of 30 g/m² and a polyester film with a width of 1,000 mm and a thickness of 30 μm with an adhesive was arranged as an intermediate layer on one surface of an adhesive non-vulcanized butyl rubber of thickness 0.5 mm and width 1,000 mm as an adhesive layer the same as Example 1. After arranging as an air-releasing layer a polyethylene flat net (manufactured by Sekisui Film Co. Ltd. trade name: Sekisui SOF GX-23) with a width of 950 mm on the other surface of the adhesive non-vulcanized butyl rubber, a release paper was applied to the surface of the net and a 20 m long sheet for waterproofing was obtained. The rate of porosity of the sheet for waterproofing was 60%.

### Example 5

The foam side of a composite formed by sticking together a polyester fiber spunbonded nonwoven fabric with a width of 1,000 mm and a mass per unit area of 30 g/m² and a polyester foam with a width of 1,000 mm, a thickness of 2 mm, and a foaming rate of 30 times with an adhesive was arranged as an intermediate layer on one surface of an adhesive non-vulcanized butyl rubber of thickness 0.5 mm and width 1,000 mm as an adhesive layer the same as Example 1. After arranging as an air-releasing layer a polyethylene flat net (manufactured by Sekisui Film Co. Ltd. trade name: Sekisui SOF HM-22) with a width of 950 mm on the other surface of the adhesive non-vulcanized butyl rubber, a release paper was applied to the surface of the net and a 20 m long sheet for waterproofing was obtained. The rate of porosity of the sheet for waterproofing was 66%.

### Example 6

To one surface of the same adhesive non-vulcanized butyl rubber of thickness 0.5 mm and width 1,000 mm in Example 1 as an adhesive layer was arranged the same nonwoven fabric in Example 1 as an intermediate layer. After a polyethylene film with a thickness of 50 μm and a width of 950 mm having pores with a diameter of 50 mm and staggered at a spacing of 50 mm is arranged as an air-releasing layer on the other surface of the adhesive non-vulcanized butyl rubber, a release paper was applied to the film surface and a 20 m long sheet for waterproofing was obtained. The rate of porosity of the sheet for waterproof was 40%.

### Example 7

To one surface of the same adhesive non-vulcanized butyl rubber of thickness 0.5 mm and width 1,000 mm in Example 1 as an adhesive layer was arranged the same nonwoven fabric in Example 1 as an intermediate layer. After an embossed polyethylene film (manufactured by Okura Industrial Co. Ltd. trade name: Embossed Film Hexagon) with a thickness of 28 μm, a width of 950 mm, and having pores with a diameter of 50 mm staggered at a spacing of 50 mm was arranged as an air-releasing layer on the other surface of the adhesive non-vulcanized butyl rubber, a release paper was applied to the film surface and a 20 m long sheet for waterproofing was obtained. The rate of porosity of the sheet for waterproofing was 40%.

### Example 8

To one surface of the same adhesive non-vulcanized butyl rubber of thickness 0.5 mm and width 1,000 mm in Example 1 as an adhesive layer was arranged the same nonwoven fabric in Example 1 as an intermediate layer. After a polyethylene net (manufactured by Nisseki Plasto Co., Ltd. trade name: CLAF EX(T)) with a thickness of 180 μm, a width of 950 mm, and having pores with a diameter of 50 mm staggered at a spacing of 50 mm was arranged as an air-releasing layer on the other surface of the adhesive non-vulcanized butyl rubber, a release paper was applied to the net surface and a 20 m long sheet for waterproofing was obtained. The rate of porosity in the sheet for waterproofing was 50%.

### Example 9

A layered body was formed by sticking together an embossed polyethylene film (manufactured by Okura Industrial Co. Ltd. trade name: Embossed Film Hexagon) with a thickness of 28 μm and a polyethylene net (manufactured by Nisseki Plasto Co., Ltd. trade name: CLAF EX(T)) with a thickness of 180 μm at vertical and horizontal spacings of 30 mm. To one surface of the same adhesive non-vulcanized butyl rubber of thickness 0.5 mm and width 1,000 mm in Example 1 as an adhesive layer was arranged the same nonwoven fabric in Example 1 as an intermediate layer. After a polyethylene film with a thickness of 50 μm, a width of 950 mm, and having pores with a diameter of 50 mm staggered at a spacing of 50 mm was arranged as an air-releasing layer on the other surface of the adhesive non-vulcanized butyl rubber, a release paper was applied to the surface facing the layered body and a 20 m long sheet for waterproofing was obtained. The rate of porosity of the sheet for waterproofing was 40%.

### Comparative Example 1

To one surface of the same adhesive non-vulcanized butyl rubber of thickness 0.5 mm and width 1,000 mm in Example 1 as an adhesive layer was arranged the same nonwoven fabric in Example 1 as an intermediate layer. A release paper was applied to the other surface and a 20 m long sheet for waterproofing was obtained.

### Air Flow Resistance Test

Measurement was carried out in accordance with Chapter 8 “Test for Air Flow Resistance Between the Substrate” in the 1986 edition of the Japanese Architectural Standard Specification (JASS-8).

### Formation of Test Specimen

To a flexible board with thickness of 6 mm, a length of 1,200 mm, and a width of 600 mm and which is provided with air grooves a synthetic rubber-based primer “Everbond CL-2” (manufactured by Secaicho Corporation) was applied at a rate of 0.2 kg per 1 m². The sheets for waterproofing obtained in each Example and the Comparative Example were stuck at a length of 1,000 mm and a width of 500 mm. To become 2 mm thick, a polyethylene-based waterproof material (manufactured by DYFLEX Co. Ltd. trade name: PLAMAX 150) was applied and a water-based inorganic top coat (manufactured by DYFLEX Co. Ltd. trade name: HG Coat) was further applied at a rate of 1.2 kg per 1 m². After being left flat to cure for one week indoors, the test specimen was formed. The finished surface of all test specimens was smooth.

The results of the air flow resistance test are shown below in Table 2.

TABLE 2

| | Amount of Air Flow (cm³/min) |
|---|---|
| Example 1 | 180 |
| Example 2 | 200 |
| Example 3 | 185 |
| Example 4 | 180 |
| Example 5 | 175 |
| Example 6 | 195 |
| Example 7 | 210 |
| Example 8 | 180 |
| Example 9 | 260 |
| Comparative Example 1 | 0 |

For Examples 1 to 9, no swelling occurred when the amount of air flow was 170 cm³/min and above.

### Examination of Swelling After the Procession of Time

The test specimens after the test for air flow resistance was finished were left exposed outside for six months and then the entire sheets for waterproofing were examined for swelling. The results are shown below in Table 3.

TABLE 3

| | Result |
|---|---|
| Example 1 | ◯ |
| Example 2 | ◯ |
| Example 3 | ◯ |
| Example 4 | ◯ |
| Example 5 | ◯ |
| Example 6 | ◯ |
| Example 7 | ◯ |
| Example 8 | ◯ |
| Example 9 | ◯ |
| Comparative Example 1 | X |

Explanation of Symbols
◯ . . . no swelling
X . . . swelling in five to ten places and irregularities are seen

### BRIEF DESCRIPTION OF THE DRAWINGS

FIG. 1 is a cross-sectional view showing an embodiment of a sheet for waterproofing of the present invention.

FIG. 2 is a plan view from the side of the air-releasing layer 1 in FIG. 1.

FIG. 3 is a cross-sectional view showing another embodiment of the sheet for waterproofing of the present invention.

FIG. 4 is a cross-sectional view showing another embodiment of the sheet for waterproofing of the present invention.

FIG. 5 is a cross-sectional view showing another embodiment of the sheet for waterproofing of the present invention.

FIG. 6 is a cross-sectional view showing the joining situation of sheets for waterproofing other than the present invention.

FIG. 7 is a cross-sectional view showing the joining situation of sheets for waterproofing of the present invention.

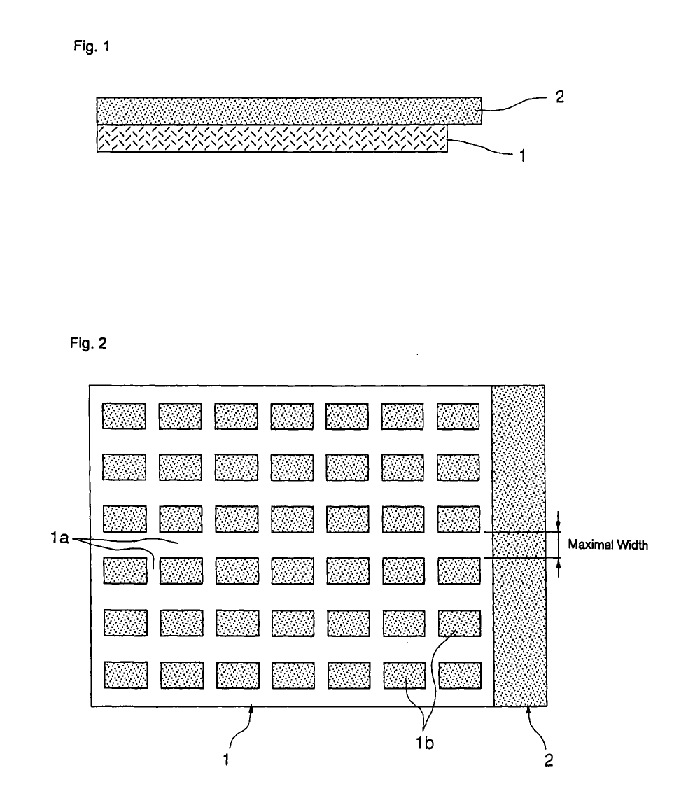

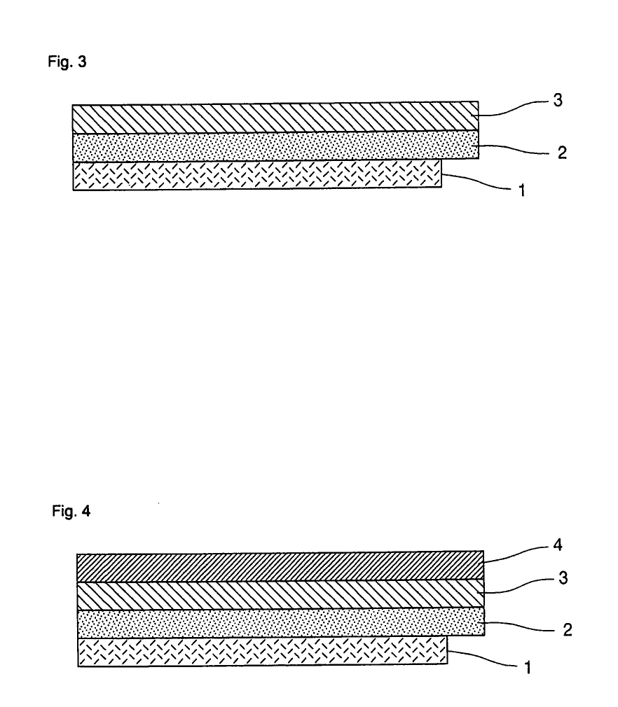

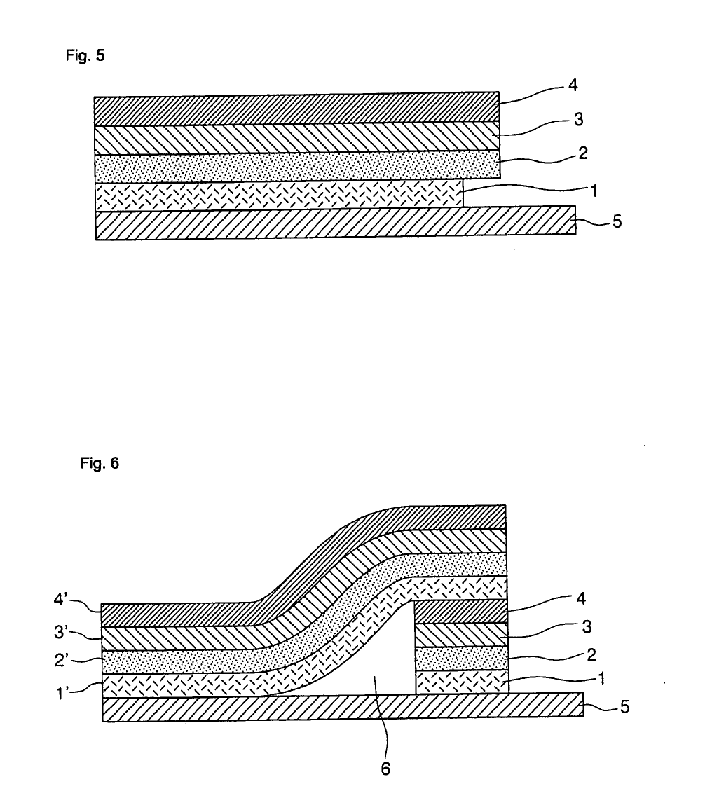

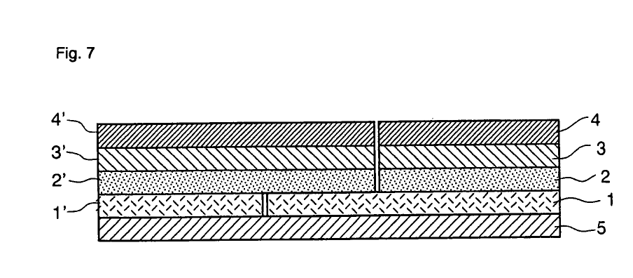

### BRIEF DESCRIPTION OF THE REFERENCE SYMBOLS

1, 1′ air-releasing layer
2, 2′ adhesive layer
3, 3′ intermediate layer
4, 4′ waterproof layer
5 substrate
6 space

1. A sheet for waterproofing comprising a layered structure of an air-releasing layer comprising a non-adhesive film or sheet having pores and an adhesive layer, wherein at least a part of the air-releasing layer and/or the adhesive layer protrudes from the layered structure.

2. A sheet for waterproofing according to claim 1, wherein the air-releasing layer has air-releasing passages with a maximum width of 3 mm to 20 mm.

3. A sheet for waterproofing according to claim 1, wherein a waterproof layer is formed on the adhesive layer.

4. A sheet for waterproofing according to claim 3, wherein an intermediate layer is provided between the adhesive layer and the waterproof layer.

5. A sheet for waterproofing according to claim 4, wherein the intermediate layer is a nonwoven fabric with an interlamellar strength of 100 g/cm or more.

6. A waterproofing method comprising a step of sticking the air-releasing layer of a sheet for waterproofing according to claim 1 to a surface of a substrate.

7. A waterproofed architecture or construction by the waterproofing method according to claim 6.
